(19) United States
(12) Patent Application Publication
(10) Pub. No.: US 2017/0041953 A1
(43) Pub. Date: Feb. 9, 2017

(54) BANDWIDTH DEPENDENT CARRIER SENSING FOR OFDMA

(71) Applicant: QUALCOMM Incorporated, San Diego, CA (US)

(72) Inventors: Yan ZHOU, San Diego, CA (US); Gwendolyn Denise BARRIAC, Encinitas, CA (US); Simone MERLIN, San Diego, CA (US); Alfred ASTERJADHI, San Diego, CA (US); George CHERIAN, San Diego, CA (US); Qingjiang TIAN, San Diego, CA (US); Gang DING, San Diego, CA (US)

(21) Appl. No.: 15/229,088

(22) Filed: Aug. 4, 2016

Related U.S. Application Data
(60) Provisional application No. 62/202,783, filed on Aug. 7, 2015.

(51) Int. Cl. H04W 74/08; H04W 72/04

(52) U.S. Cl. CPC H04W 74/0808; H04W 72/0453

(57) ABSTRACT

Certain aspects of the present disclosure generally relate to wireless communications and, more particularly, to bandwidth dependent carrier sensing for orthogonal frequency division multiple access (OFDMA). One example apparatus for wireless communications generally includes a first interface for obtaining at least a first frame with an indication of a time duration during which at least one bandwidth channel is occupied; a processing system configured to track, based at least in part on the indicated duration, availability of time and one or more resources on a plurality of bandwidth channels including the at least one bandwidth channel and to determine whether resources are available to transmit at least a second frame, based on the tracked availability; and a second interface for outputting the second frame for transmission if the determination indicates resources are available.

### CROSS-REFERENCE TO RELATED APPLICATIONS

The present application for patent claims priority to U.S. Provisional Application No. 62/202,783, filed Aug. 7, 2015, which is assigned to the assignee of the present application and hereby expressly incorporated by reference herein in its entirety.

### BACKGROUND

Field of the Disclosure

Certain aspects of the present disclosure generally relate to wireless communications and, more specifically, to bandwidth dependent carrier sensing for orthogonal frequency division multiple access (OFDMA).

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz frequency range (e.g., operating in the 902-928 MHz range in the United States) being developed by the Institute of Electrical and Electronics Engineers (IEEE) 802.11ah task force. This development is driven by the desire to utilize a frequency range that has greater wireless range than wireless ranges associated with frequency ranges of other IEEE 802.11 technologies and potentially fewer issues associated with path losses due to obstructions.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide techniques for bandwidth dependent carrier sensing for OFDMA.

Certain aspects of the present disclosure provide an apparatus for wireless communications. The apparatus generally includes a first interface configured to obtain at least a first frame with an indication of a time duration during which at least one bandwidth channel is occupied, a processing system configured to determine, based at least in part on the indicated time duration, whether at least one of time or frequency resources are available on a plurality of bandwidth channels including the at least one bandwidth channel, wherein none of the plurality of bandwidth channels overlap in frequency and to generate a second frame if it is determined that the at least one of time or frequency resources on the plurality of bandwidth channels are available, and a second interface configured to output the second frame for transmission if the determination indicates at least some of the resources are available.

Certain aspects of the present disclosure provide a method for wireless communications. The method generally includes obtaining at least a first frame with an indication of a time duration during which at least one bandwidth channel is occupied determining, based at least in part on the indicated time duration, whether at least one of time or frequency resources are available on a plurality of bandwidth channels including the at least one bandwidth channel, wherein none of the plurality of bandwidth channels overlap in frequency and generating a second frame if it is determined that the at least one of time or frequency resources on the plurality of bandwidth channels are available, and outputting the second frame for transmission if the determination indicates at least some of the time are frequency resources are available.

Certain aspects of the present disclosure provide an apparatus for wireless communications. The apparatus generally includes means for obtaining at least a first frame with an indication of a time duration during which at least one bandwidth channel is occupied, means for determining, based at least in part on the indicated time duration, whether at least one of time or frequency resources are available on a plurality of bandwidth channels including the at least one bandwidth channel, wherein none of the plurality of bandwidth channels overlap in frequency and means for generating a second frame if it is determined that the at least one of time or frequency resources on the plurality of bandwidth channels are available, and means for outputting the second frame for transmission if the determination indicates at least some of the time are frequency resources are available.

Certain aspects of the present disclosure provide computer readable storage medium having instructions stored thereon for wireless communications. The instructions generally include instructions for obtaining at least a first frame with an indication of a time duration during which at least one bandwidth channel is occupied, instructions for determining, based at least in part on the indicated time duration, whether at least one of time or frequency resources are available on a plurality of bandwidth channels including the at least one bandwidth channel, wherein none of the plurality of bandwidth channels overlap in frequency and generating a second frame if it is determined that the at least one of time or frequency resources on the plurality of bandwidth channels are available, and outputting the second frame for transmission if the determination indicates at least some of the time are frequency resources are available

Certain aspects of the present disclosure provide a wireless station. The wireless station generally includes at least one antenna, a receiver configured to receive, via the at least one antenna, at least a first frame with an indication of a time duration during which at least one bandwidth channel is occupied, a processing system configured to determine, based at least in part on the indicated time duration, whether at least one of time or frequency resources are available on a plurality of bandwidth channels including the at least one bandwidth channel, wherein none of the plurality of bandwidth channels overlap in frequency and to generate a second frame if it is determined that the at least one of time or frequency resources on the plurality of bandwidth channels are available, and a transmitter configured to transmit, via the at least one antenna, the second frame if the determination indicates at least some of the time are frequency resources are available.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point (AP) and user terminals (UTs), in accordance with certain aspects of the present disclosure.

FIG. 3 illustrates a block diagram of an example wireless device, in accordance with certain aspects of the present disclosure.

FIG. 4 illustrates an example transmission timeline.

FIG. 5 illustrates example operations for wireless communications, in accordance with certain aspects of the present disclosure.

FIG. 5A illustrates example means capable of performing the operations shown in FIG. 5.

FIG. 6 illustrates an example transmission timeline, in accordance with certain aspects of the present disclosure.

FIG. 7 illustrates an example transmission timeline, in accordance with certain aspects of the present disclosure.

FIG. 8 illustrates an example transmission timeline, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure provide techniques for bandwidth dependent virtual carrier sensing. Virtual carrier sensing is a technique wherein a wireless device may determine, based on information the device obtains, that a transmission medium (e.g., a bandwidth) is occupied without the wireless device actually sensing (e.g., with a receiver) the transmission medium. The virtual carrier sensing is a logical abstraction that may reduce physical carrier-sensing at the air interface of a device, possibly saving power. Disclosed techniques may enable a device to individually track the availability of bandwidths of the transmission medium, instead of tracking the entire medium as available or unavailable.

A network allocation vector (NAV) is a virtual carrier-sensing mechanism used with wireless network protocols (e.g., such as IEEE 802.11 (Wi-Fi) and IEEE 802.16 (WiMax)). The NAV may be thought of as a counter, which counts down to zero at a uniform rate. When the counter is zero, the virtual carrier sensing indication is that the medium is idle; when the counter is not zero, the indication is that the medium is busy. For example, medium access control (MAC) layer frame headers of a frame may contain a Duration field that specifies the transmission time required for the frame, during which time the medium will be busy. A station listening on the wireless medium may read the Duration field of the frame and set a NAV of the station based on the Duration field. The station may then defer from accessing (e.g., transmitting on) the medium until the NAV has counted down to zero.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Techniques and apparatus are provided herein for bandwidth dependent carrier sensing for orthogonal frequency division multiple access (OFDMA). In aspects, techniques are provided for obtaining at least a first frame with an indication of a time duration during which at least one bandwidth channel is occupied; tracking, based at least in part on the indicated duration, availability of time and one or more resources on a plurality of bandwidth channels including the at least one bandwidth channel; determining whether resources are available to transmit at least a second frame based on the tracked availability; and outputting the second frame for transmission if the determination indicates resources are available.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may use sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system uses orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may use interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium.

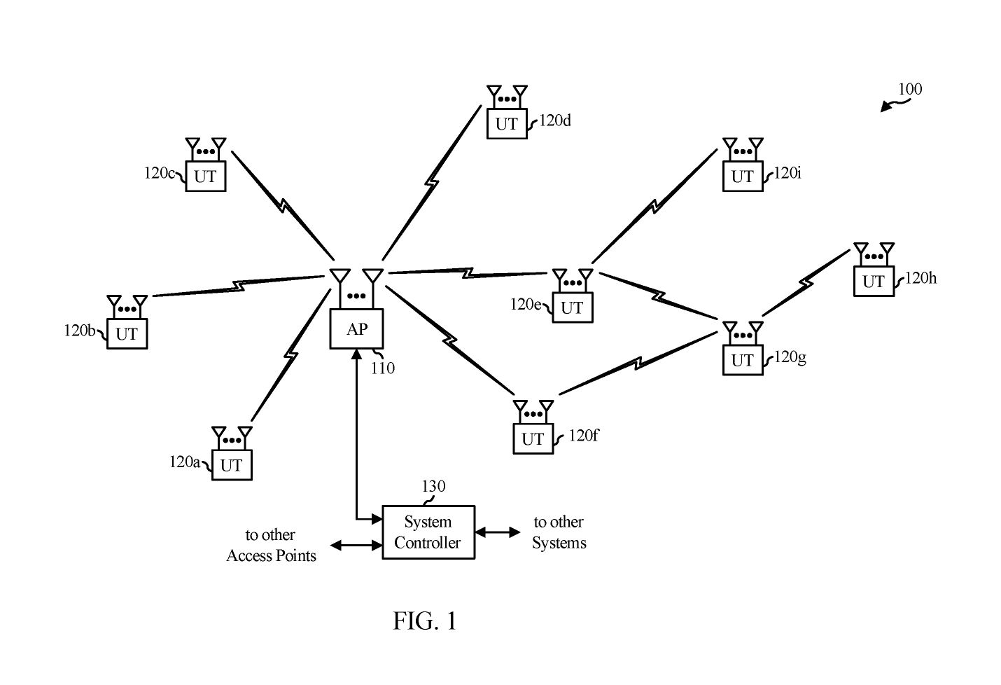

FIG. 1 illustrates a system 100 in which aspects of the disclosure may be performed. For example, the user terminal 120 may obtain (e.g., from AP 110) at least a first frame with an indication of a time duration during which at least one bandwidth channel is occupied. The user terminal 120 may track, based at least in part on the indicated duration, availability of time and one or more resources on a plurality of bandwidth channels including the at least one bandwidth channel and determine whether resources are available to transmit at least a second frame based on the tracked availability. The user terminal 120 may then output the second frame for transmission if the determination indicates resources are available.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a station (STA), an access terminal, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 may couple to and provide coordination and control for the access point.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also use a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to a different user terminal 120.

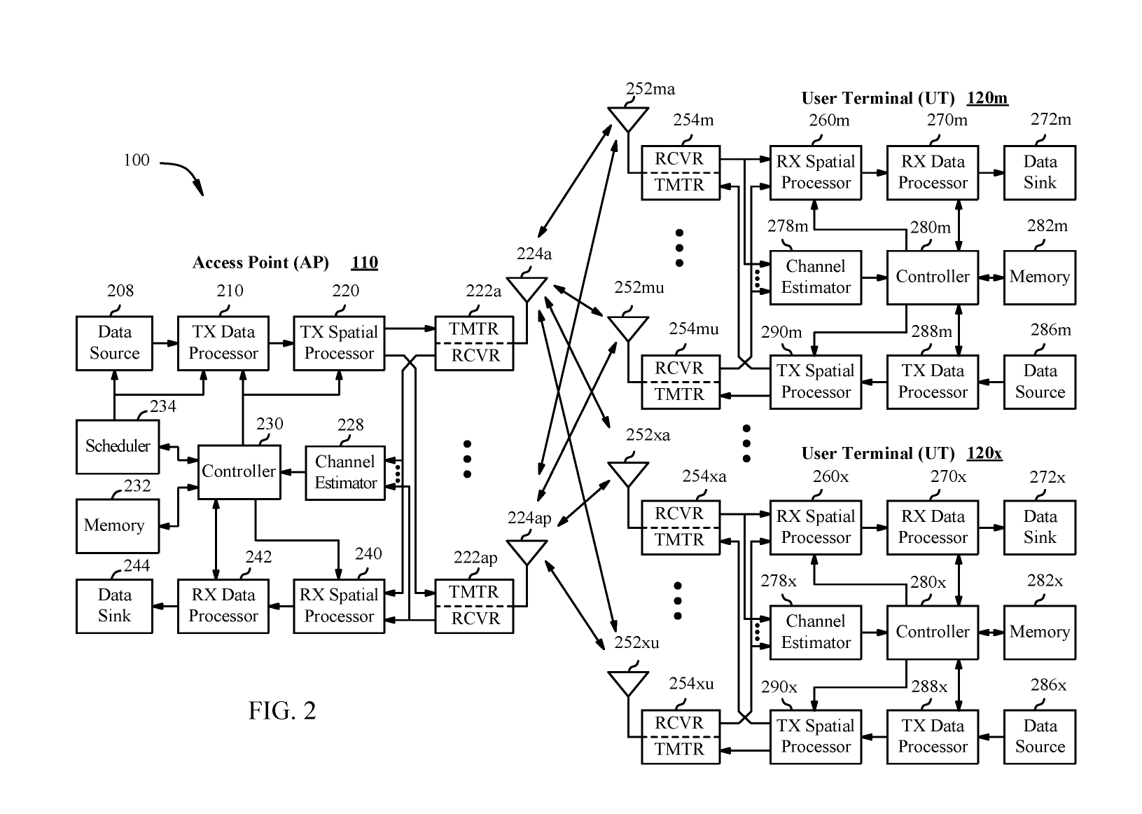

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 may be used to perform the operations described herein and illustrated with reference to FIGS. 17-18A. Similarly, antenna 252, Tx/Rx 254, processors 260, 270, 288, and 290, and/or controller 280 of the UT 120 may be used to perform the operations described herein and illustrated with reference to FIGS. 17-18A.

FIG. 2 illustrates a block diagram of access point 110 and two user terminals 120m and 120x in MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while N_{dn} user terminals simultaneously transmit on the downlink. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix Hdn,m for that user terminal. Controller 230 derives the spatial filter matrix for the access point based on the effective uplink channel response matrix Hup,eff. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

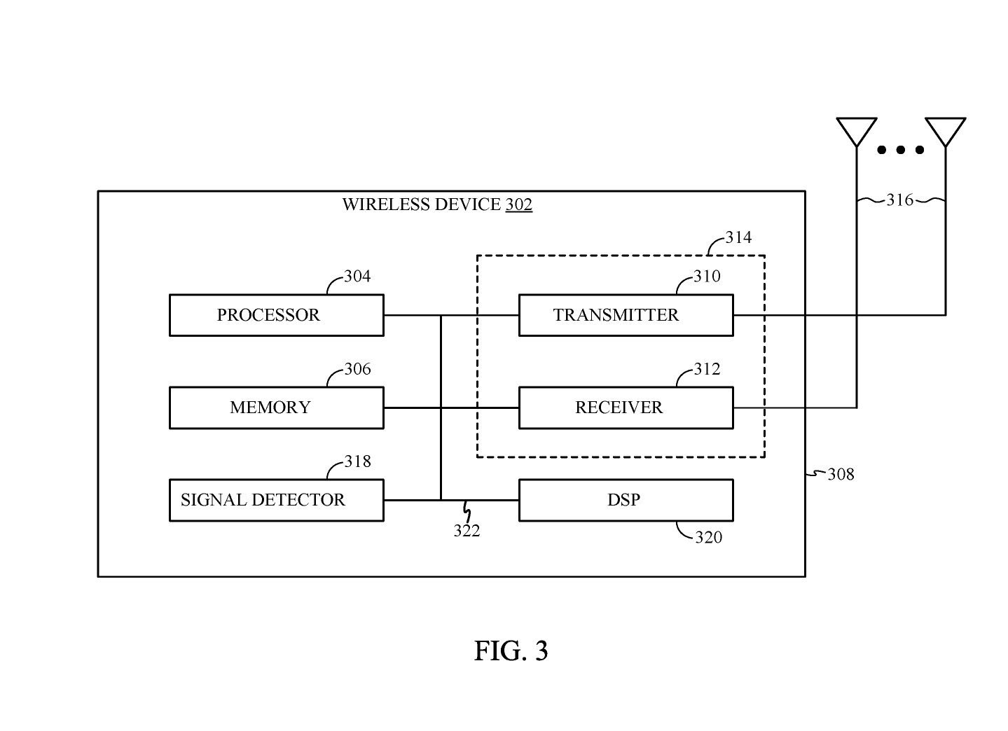

FIG. 3 illustrates example components that may be utilized in the AP 110 and/or UT 120 to implement aspects of the present disclosure. For example, the transmitter 310, antenna(s) 316, processor 304 and/or the digital signal processor (DSP) 320 may be used to practice aspects of the present disclosure implemented by the AP. Further, the receiver 312, antenna(s) 316, processor 304 and/or the DSP 320 may be used to practice aspects of the present disclosure implemented by the UT.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Downlink Dependent Carrier Sensing for OFDMA

In multiple access communication systems, multiple stations may send and receive transmissions on a shared transmission medium. Carrier sense (CS) is an access protocol in which a node verifies the absence of other traffic before transmitting on a shared transmission medium, such as a band of the electromagnetic spectrum (e.g., bandwidth). For carrier sense, the node attempts to detect the presence of a carrier wave from another station before attempting to transmit. If a carrier is sensed, the node may wait for a transmission in progress to finish before the node initiates a transmission.

As mentioned above, virtual carrier sensing is a technique wherein a wireless device may determine, based on information the device obtains, that a transmission medium (e.g., a bandwidth) is occupied without the wireless device actually sensing (e.g., with a receiver) the transmission medium. The virtual carrier sensing is a logical abstraction that may reduce physical carrier sensing at the air interface of a device, possibly saving power. A network allocation vector (NAV) is a virtual carrier-sensing mechanism used with wireless network protocols (e.g., such as IEEE 802.11 (Wi-Fi) and IEEE 802.16 (WiMax)). For example, medium access control (MAC) layer frame headers, a MAC layer payload of a frame, and/or a physical layer (PHY) header of a frame may contain an indication (e.g., a Duration field) that specifies the transmission time required for the frame, during which time the medium will be busy. Stations listening on the wireless medium may read the Duration field and set their NAVs, each of which is an indicator for a station of how long the station should defer from accessing the medium. The NAV may be thought of as a counter, which counts down to zero at a uniform rate. When the counter is zero, the virtual CS indication is that the medium is idle; when the counter is not zero, the virtual CS indication is that the medium is busy.

Wireless stations (e.g., nodes) are often battery-powered, so to conserve power the stations may enter a power-saving mode (e.g., a sleep mode). While in the power-saving mode, a station may determine to send a transmission (e.g., data from an application) to another node. The station does not immediately activate a receiver to sense the medium in preparation for starting the transmission, but instead the station decrements its NAV counter until the NAV becomes zero, at which time the station activates the receiver to sense the medium to determine if the medium is idle and the station can begin transmitting.

In certain systems, for example, uplink (UL) orthogonal division multiple access (OFDMA), an access point (AP) may send a trigger frame to schedule multiple STAs to transmit in different bandwidths. In some cases, the scheduled bandwidth per STA may be less or more than 20 MHz, and may be discontinuous. The STAs may be scheduled for transmission of data or control information.

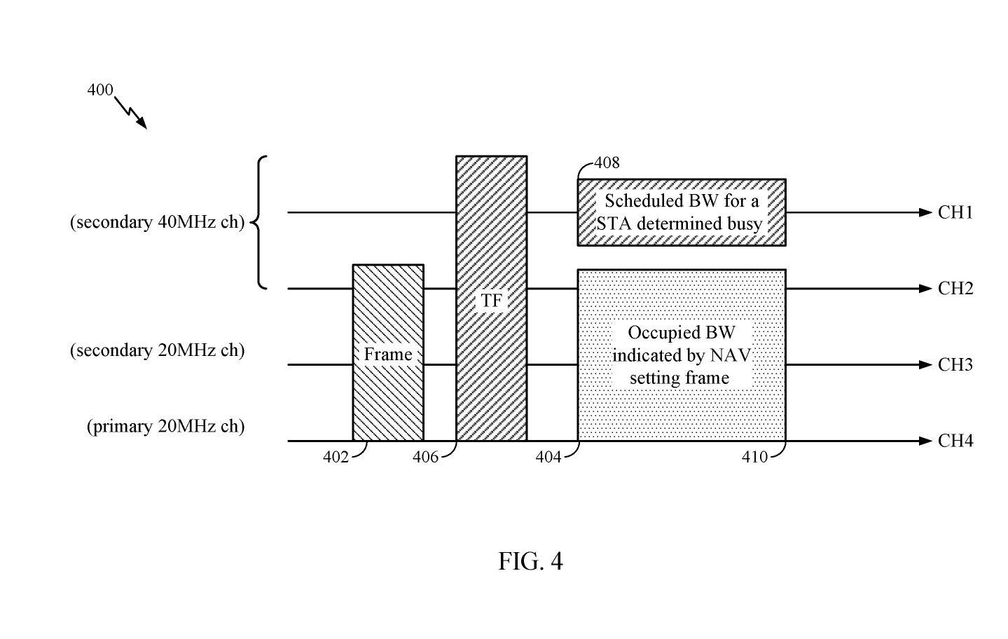

A STA receiving a trigger frame (e.g., a frame scheduling the STA for a transmission) may check the NAV set (to non-zero values) by frames received before the trigger frame to determine whether the shared medium is busy before transmitting the transmission being scheduled by the trigger frame. In some implementations, the NAV setting frames (e.g., frames having Duration field(s)) may be received on a primary 20 MHz channel before the trigger frame. According to prior technologies (e.g., IEEE 802.11n), if the NAV has been set, the STA will determine that the scheduled bandwidth is busy and not respond to the trigger frame, even if the NAV setting frame does not occupy the scheduled bandwidth, as shown in FIG. 4.

FIG. 4 illustrates an example transmission timeline 400, according to previously known techniques. At 402 a frame (e.g., transmitted by STA 120g, shown in FIG. 1) is received by a STA (e.g., STA 120f shown in FIG. 1). The frame at 402 may indicate that a transmission on channels 2, 3, and 4 is to occur during the duration from time 404 to time 410. The frame at 402 may be, for example, a clear-to-send (CTS) frame that STA 120g is sending to STA 120h. The STA (e.g., STA 120f) may receive the frame and set a NAV of the STA indicating that the bandwidth of channels 1, 2, 3, and 4 is occupied (i.e., not idle) during the duration from time 404 to time 410, based on a duration and/or other fields within the frame. At 406, the STA (e.g., STA 120f) may receive a trigger frame (e.g., transmitted by AP 110, shown in FIG. 1) requesting the STA to transmit a transmission (e.g., another frame) 408 on channel 1 during a duration beginning at time 404. According to previously known techniques, the STA will not transmit the requested transmission 408 because the NAV of the STA indicates that the medium is occupied for the duration from time 404 to time 410, despite the bandwidth of channel 1 not being occupied during the duration from time 404 to time 410. Accordingly, techniques for bandwidth dependent carrier sensing are desirable.

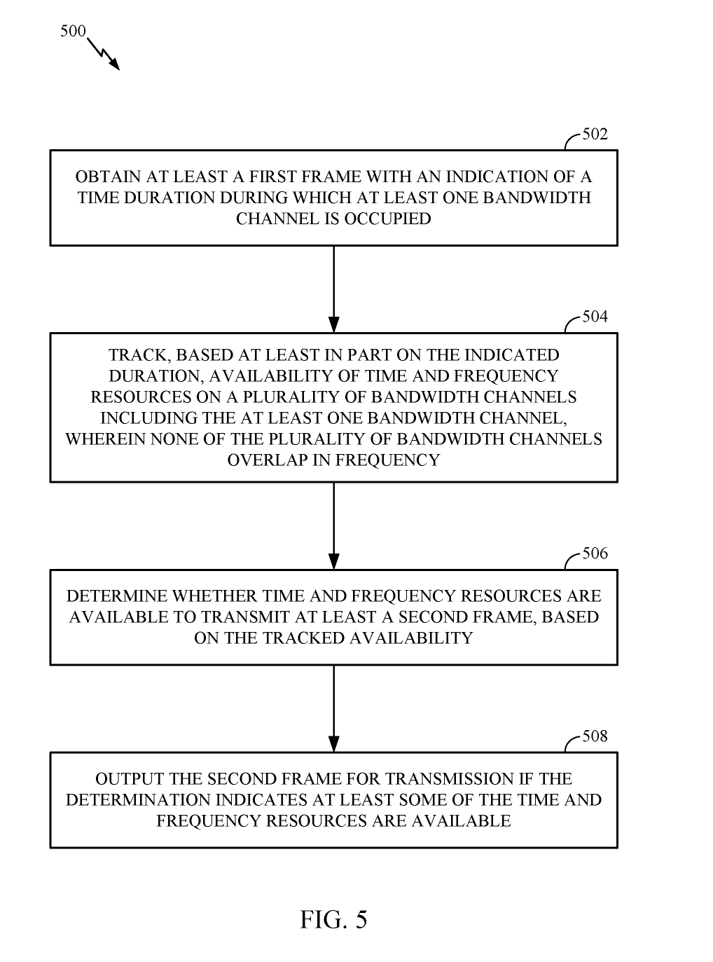

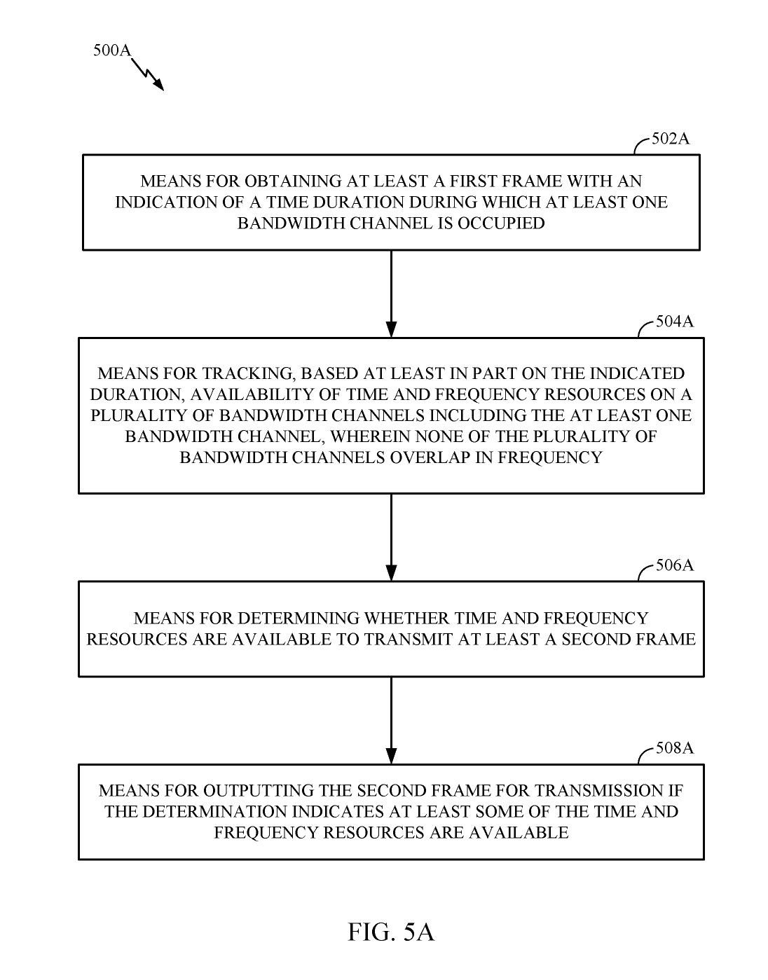

FIG. 5 illustrates example operations 500 for wireless communications, in accordance with certain aspects of the present disclosure. Operations 500 may be performed, for example, by a STA (e.g., STA 120, shown in FIG. 1).

Operations 500 may begin, at 502, by the STA obtaining at least a first frame with an indication of a time duration during which at least one bandwidth channel is occupied. For example and with reference to FIG. 4, a STA may receive a frame 402 indicating a bandwidth of channels 2, 3, and 4 is occupied during a duration from 404 to 410.

The STA may then determine, based at least in part on the indicated time duration, whether at least one of time or frequency resources are available on a plurality of bandwidth channels including the at least one bandwidth channel, wherein none of the plurality of bandwidth channels overlap in frequency.

For example, at 504, the STA may track, based at least in part on the indicated duration, availability of time and one or more resources on a plurality of bandwidth channels including the at least one bandwidth channel, wherein none of the plurality of bandwidth channels overlap in frequency. Continuing the example above, the STA may track the availability of the channel 1 as being available and the channels 2, 3, and 4 as not being available during the duration from 404 to 410.

At 506, the STA may determine whether time and frequency resources are available to transmit at least a second frame, based on the tracked availability. Continuing the example above, the STA may determine that channel 1 is available to transmit a second frame during the duration from 404 to 410, based on the previously tracked availability of channels 1, 2, 3, and 4. The STA may then generate the second frame if it is determined that the at least one of time or frequency resources on the plurality of bandwidth channels are available.

At 508, the STA may output the second frame for transmission if the determination indicates at least some of the time and frequency resources are available. Continuing the example above, the STA may output the second frame on 1, as the determination was that 1 was available during the duration from 404 to 410.

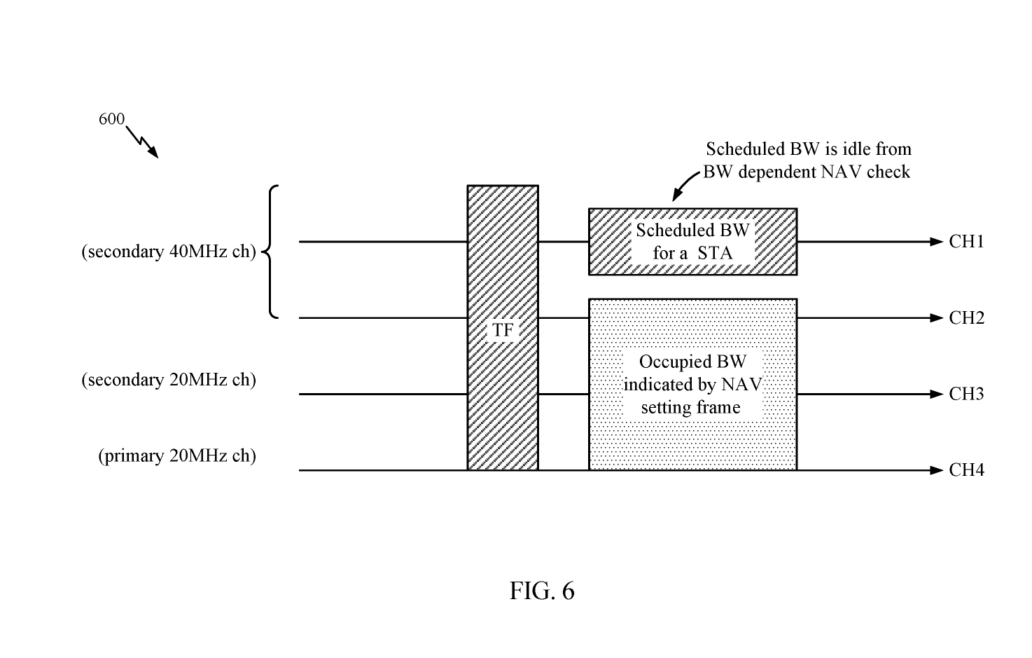

According to aspects of the present disclosure, a NAV check (e.g., by a STA) may be bandwidth dependent. A STA may check reservations (e.g., indicated in a NAV as described in aspects of the present disclosure) in both time and frequency to identify unoccupied bandwidth. Scheduled bandwidth for a STA may be determined to be idle with respect to a NAV, if the bandwidth is not overlapped with occupied bandwidth indicated by a NAV setting frame (e.g., on the primary channel) as shown in the exemplary transmission timeline 600 in FIG. 6.

### Example NAV Per 20 MHz

According to aspects of the present disclosure, a STA may maintain multiple NAVs associated with multiple bandwidths. That is, a STA may maintain a NAV associated with each of a plurality of bandwidths supported by the STA. For example, a STA may maintain a NAV for every 20 MHz channel in an operating bandwidth of the STA. A STA may maintain a NAV(x) that corresponds to the NAV for the x-th 20 MHz channel.

According to aspects of the present disclosure, for each valid frame having a Duration field received by a STA and not addressed to the STA, the STA may compute one or more corresponding NAV value(s) (e.g., time(s) to count down) and occupied bandwidth(s), where the latter may be indicated in the physical layer convergence protocol (PLCP) protocol data unit (PPDU) carrying the frame. The STA may set the NAV(x) corresponding to the appropriate channels if the computed NAV(x) is greater than the current NAV(x). The NAV(x) may count down as time elapses in the same way as NAVs of previously known wireless communication technologies (e.g., IEEE 802.11n).

According to aspects of the present disclosure, after receiving a trigger frame, the STA may check idleness for the entire scheduled bandwidth to determine whether to respond. For example, after receiving the trigger frame the STA may determine that the scheduled bandwidth is idle if all of the channels overlapping the scheduled bandwidth have a NAV(x)=0. The node may transmit or not transmit on the entire scheduled bandwidth based on whether the NAV check determines the entire scheduled bandwidth to be busy or idle.

Additionally or alternatively, the STA may check idleness for each minimum allocation of a scheduled bandwidth (e.g., scheduled by an AP for the STA to transmit a frame). That is, a scheduled bandwidth may include a plurality of minimum allocation bandwidths, where a minimum allocation bandwidth is a smallest portion of bandwidth that an AP will allocate to a STA (e.g., for an OFDMA MIMO uplink transmission), and the STA may maintain a NAV for each minimum allocation bandwidth of the scheduled bandwidth. For example, a scheduled bandwidth may be a 10 MHz bandwidth including multiple minimum allocated bandwidths (e.g., 2.5 MHz allocations). In the example, after a STA receives a trigger frame requesting the STA to transmit a frame in the scheduled bandwidth, the STA may determine whether each minimum allocated bandwidth of the scheduled bandwidth is idle or busy by checking an associated NAV(x) of channels overlapping the scheduled bandwidth. The STA may determine to transmit or not transmit on each minimum allocated bandwidth based on whether the NAV check determines the minimum allocated bandwidth to be busy or idle. In a second example, a STA may operate on a 10 MHz bandwidth that is divided into four channels, each 2.5 MHz wide. In the second example, the STA may receive one or more NAV setting frames (e.g., frames indicating a bandwidth will be occupied for a period of time) indicating that channels 1 and 3 are occupied for a time t. Continuing the second example, the STA may receive a trigger frame requesting the STA to transmit during time t. Still in the second example, the STA may respond to the trigger frame by transmitting on channel 2 and/or channel 4, because the STA tracks the availability of each channel separately and is able to determine that channel 2 and channel 4 are not occupied during time t.

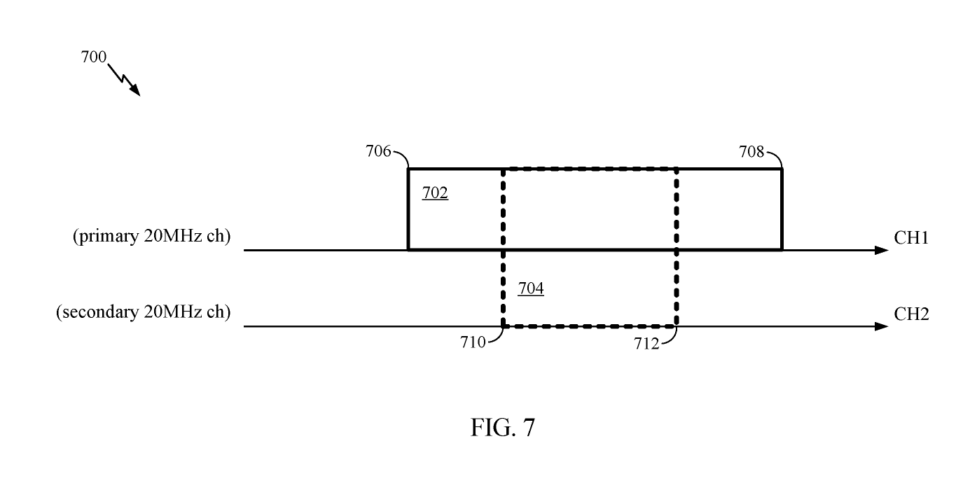

FIG. 7 illustrates an example transmission timeline 700, in accordance with certain aspects of the present disclosure. As shown in FIG. 7, a node (e.g., STA 120 shown in FIG. 1) operating on an 80 MHz bandwidth may receive two NAV setting frames (e.g., frames indicating a bandwidth will be occupied for a period of time) 702, 704 on the primary channel 1. The duration and occupied bandwidth indicated by the first frame 702 may indicate that channel 1 is busy (e.g., not idle) during the duration starting at 706 and ending at 708, and the duration and occupied bandwidth indicated by the second frame 704 may indicate that channels 1 and 2 are busy during the duration starting at 710 and ending at 712. In the exemplary transmission timeline, at 702, when the first frame is received, the STA may set NAV(1) to indicate channel 1 is busy until 708 and NAV(2) to indicate channel 2 is idle, because the first frame does not indicate channel 2 to be busy. At 710, when the second frame 704 is received, the STA may then set NAV(2) to indicate channel 2 is busy until 712. Thus, if a trigger frame is received between 710 and 712, the bandwidth scheduled by the trigger frame may be idle, if the bandwidth does not overlap with channel 1 or channel 2.

### Example NAV Plus Channel Busy Vector (CBV)

According to aspects of the present disclosure, a STA may maintain a channel busy vector (CBV) to indicate the busy/idle status of multiple bandwidths (e.g., each 20 MHz channel) of an operating bandwidth (e.g., a 160 MHz bandwidth). For example, a CBV of (1,1,0,0) may indicate that channel 1 and channel 2 are currently busy and that channel 3 and channel 4 may be idle. According to aspects of the present disclosure, for every valid received frame with a Duration field not addressed to a receiving STA, the STA may compute a new NAV value and occupied bandwidth, where the occupied bandwidth may be indicated in the PPDU carrying the frame. If the computed new NAV has a longer period to count down than a current NAV being maintained by the STA, the STA may set the computed new NAV as the NAV. That is, the STA may replace the current NAV with the computed new NAV. For every value indicating a channel is idle (e.g., 0) in a CBV maintained by the STA, the STA may set the value to a value indicating the channel is busy (e.g., 1), if the corresponding channel overlaps with occupied bandwidth indicated by the received frame. The NAV may count down as time elapses in the same manner as a NAV in previously existing wireless communication technologies (e.g., IEEE 802.11n).

According to aspects of the present disclosure, if the NAV maintained by a STA counts down to 0, a CBV maintained by the STA may be set to indicate that the entire operating bandwidth is idle (e.g., every entry of the CBV may be set to 0). Additionally or alternatively, a STA may reset an individual entry in a CBV from to indicate a particular channel is unoccupied, before the NAV counts down to 0, if the STA has information regarding how long the individual entry should last (e.g., the STA has information regarding a duration of a transmission in a particular channel of the bandwidth).

According to aspects of the present disclosure, after receiving a trigger frame, a STA may check idleness for an entire scheduled bandwidth to determine whether to respond. For example, after receiving a trigger frame requesting the STA to transmit on a scheduled bandwidth, a STA may determine that the scheduled bandwidth is idle if all entries in a CBV corresponding to channels overlapping the scheduled bandwidth have a value indicating idle (e.g., 0). In the example, the STA may determine to transmit or to not transmit on the entire scheduled bandwidth based on whether the CBV check determines the entire scheduled bandwidth is busy or idle.

Additionally or alternatively, a STA may check idleness for each minimum allocation of a scheduled bandwidth (e.g., scheduled by an AP for the STA to transmit a frame). That is, a scheduled bandwidth may include a plurality of minimum allocation bandwidths, where a minimum allocation bandwidth is a smallest portion of bandwidth that an AP will allocate to a STA (e.g., for an OFDMA MIMO uplink transmission), and the STA may maintain an entry in a CBV for each minimum allocation bandwidth of the scheduled bandwidth. For example, a scheduled bandwidth may be a 10 MHz bandwidth including multiple minimum allocated bandwidths (e.g., 2.5 MHz allocations). In the example, after a STA receives a trigger frame requesting the STA to transmit a frame in the scheduled bandwidth, the STA may determine whether each minimum allocated bandwidth of the scheduled bandwidth is idle or busy by checking the entries of the CBV associated with channels overlapping the scheduled bandwidth. The STA may determine to transmit or not transmit on each minimum allocated bandwidth based on whether the CBV check determines the minimum allocated bandwidth to be busy or idle.

Referring back to FIG. 7, when the STA receives the first frame, at 706, the STA may set the CBV to (1,0,0,0) to indicate that channel 1 is busy. When the STA receives a second frame, at 710, the STA may set the CBV to (1,1,0,0) to indicate that channel 1 and channel 2 are busy. In this example, the CBV is shown as four bits, each bit representing a 20 MHz channel; however, the disclosure is not so limited; the CBV could be more or less than four bits, and each bit could represent a bandwidth larger or smaller than 20 MHz.

According to aspects of the present disclosure, bandwidth occupied by a transmission (e.g., a frame) may be signaled in a very high throughput (VHT)-SIG-A field of a VHT PPDU or in a service field of a non-HT duplicate request-to-send (RTS) or clear-to-send (CTS) message. From the signaled bandwidth, a receiving node may identify which 20, 40, or 80 MHz channel is occupied based on the channelization plan in the 5 GHz frequency band. In the case of a non-HT duplicate RTS/CTS, the occupied bandwidth may also be determined based on PHY detection (e.g., via correlation detection across different bandwidths). According to aspects of the present disclosure, the occupied bandwidth may be signaled in a PHY or MAC header of a PPDU, a trigger frame in UL OFDMA communications, or a SIG-B field of a data frame in DL OFDMA communications. According to aspects of the present disclosure, the occupied bandwidth of non-duplicate non-HT frames, such as a non-HT data frame, may be treated as 20 MHz.

According to aspects of the present disclosure, a receiving STA may check PPDU duration in a received PPDU preamble, which reserves the time duration for the PPDU. According to aspects of the present disclosure, the STA may perform a bandwidth dependent preamble check according to the techniques described above, except instead of tracking NAV duration, the STA may check PPDU duration.

According to aspects of the present disclosure, the techniques described above may be applied to other types of OFDMA schemes. For example, for UL OFDMA with random access, instead of a STA performing bandwidth dependent carrier sensing to determine whether to send a transmission scheduled by a trigger frame, a trigger frame may indicate bandwidths available for random access. In this case, the allowed STAs may randomly select one or multiple bandwidths for transmission. Bandwidth dependent carrier sense may be used to determine the busy/idle state of the indicated bandwidths available for random access such that a STA receiving the trigger frame and requested to transmit may select from among only the idle bandwidths for transmission.

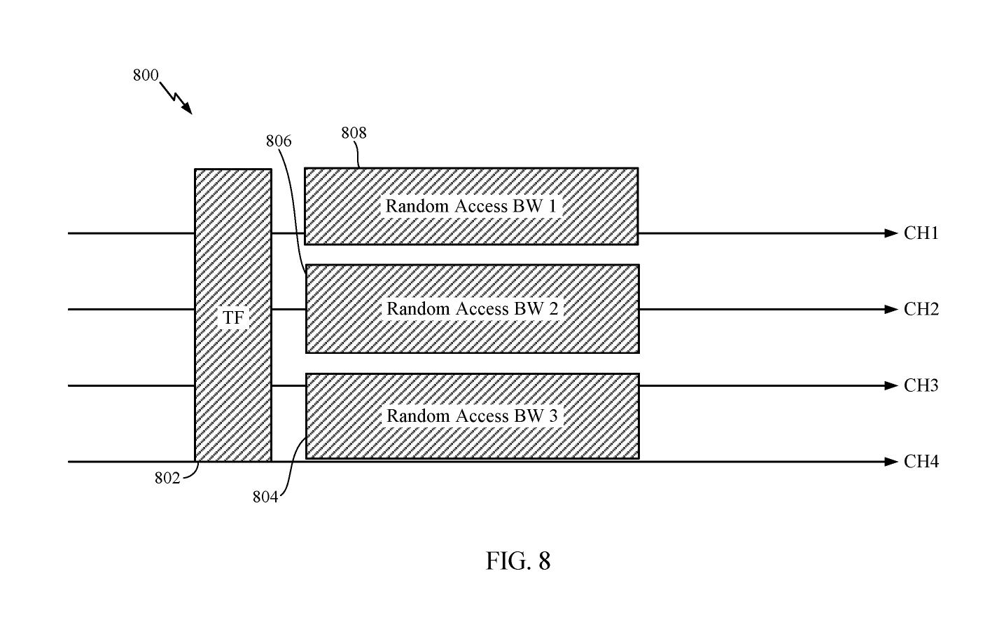

FIG. 8 shows an exemplary transmission timeline 800, according to aspects of the present disclosure. A trigger frame 802 may indicate that bandwidths 804, 806, and 808 are available for random access. A STA that is requested to transmit by the trigger frame may determine the busy/idle state of the bandwidths 804, 806, and 808 and not sense the busy/idle state of other bandwidths, before making the requested transmission.

According to aspects of the present disclosure, bandwidth dependent carrier sense may be used for DL OFDMA, where an AP can determine the busy/idle state of potentially scheduled bandwidths (i.e., bandwidths on which the AP may transmit the DL OFDMA transmissions) based on the bandwidth dependent carrier sensing. Bandwidth dependent carrier sensing may also be used in DL/UL OFDMA+multiple input multiple output (MIMO), where multiple STAs are packed in spatial domain per scheduled bandwidth, and AP and/or STAs can determine the busy/idle state per scheduled bandwidth. That is, when transmissions to or from multiple STAs are scheduled using MIMO, the scheduling AP and/or the STAs may use bandwidth dependent carrier sensing to determine the busy/idle state of one or more scheduled bandwidths.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 illustrated in FIG. 5 corresponds to means 500A illustrated in FIG. 5.

For example, means for transmitting (or means for outputting for transmission) may comprise a transmitter (e.g., the transceiver 222) and/or an antenna(s) 224 of the access point 110, the transmitter (e.g., the transceiver 254) and/or antenna(s) 252 of the user terminal 120 illustrated in FIG. 2, and/or the transmitter 310 and/or antenna(s) 316 of the wireless device 302 illustrated in FIG. 3. Means for receiving (or means for obtaining) may comprise a receiver (e.g., the transceiver 222) and/or an antenna(s) 224 of the access point 110, the receiver (e.g., the transceiver 254) and/or antenna(s) 252 of the user terminal 120 illustrated in FIG. 2, and/or the receiver 312 and/or antenna(s) 316 of the wireless device 302 illustrated in FIG. 3. Means for tracking, means for indicating, means for determining, means for tracking, means for deciding, and means for scheduling may comprise a processing system, which may include one or more processors, such as the RX data processor 242, the RX spatial processor 240, the TX data processor 210, the TX spatial processor 220, and/or the controller 230 of the access point 110, the RX data processor 270, the RX spatial processor 260, the TX data processor 288, the TX spatial processor 290, and/or the controller 280 of the user terminal 120 illustrated in FIG. 2, and/or the signal detector 318 and/or the processor 304 of the wireless device 302.

According to certain aspects, such means may be implemented by processing systems configured to perform the corresponding functions by implementing various algorithms (e.g., in hardware or by executing software instructions) described above for providing an immediate response indication in a PHY header. For example, an algorithm for obtaining at least a first frame with an indication of a time duration during which at least one bandwidth channel is occupied, an algorithm for tracking, based at least in part on the indicated duration, availability of time and one or more resources on a plurality of bandwidth channels including the at least one bandwidth channel, an algorithm determining whether resources are available to transmit at least a second frame based on the tracked availability, and an algorithm for outputting the second frame for transmission if the determination indicates resources are available.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for obtaining at least a first frame with an indication of a time duration during which at least one bandwidth channel is occupied, instructions for tracking, based at least in part on the indicated duration, availability of time and one or more resources on a plurality of bandwidth channels including the at least one bandwidth channel, instructions for determining whether resources are available to transmit at least a second frame based on the tracked availability, instructions for outputting the second frame for transmission if the determination indicates resources are available.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communication, comprising:
a first interface configured to obtain at least a first frame with an indication of a time duration during which at least one bandwidth channel is occupied;
a processing system configured to:
determine, based at least in part on the indicated time duration, whether at least one of time or frequency resources are available on a plurality of bandwidth channels including the at least one bandwidth channel, wherein none of the plurality of bandwidth channels overlap in frequency, and
generate a second frame if it is determined that the at least one of time or frequency resources on the plurality of bandwidth channels are available; and
a second interface configured to output the second frame for transmission via the at least one of time or frequency resources determined available on the plurality of bandwidth channels.

2. The apparatus of claim 1, wherein:
the indication further comprises an indication of which of the plurality of bandwidth channels are unavailable during the time duration.

3. The apparatus of claim 1, wherein:
the indication further comprises an indication of a separate duration, for each unavailable bandwidth channel of the plurality of bandwidth channels, during which the respective unavailable bandwidth channel is occupied.

4. The apparatus of claim 1, wherein:
the first interface is further configured to obtain a trigger frame; and
the processing system is further configured to cause the second interface to output the second frame after reception of the trigger frame.

5. The apparatus of claim 4, wherein:
the trigger frame indicates the apparatus is to output the second frame for transmission on a scheduled bandwidth portion of one of the plurality of bandwidth channels; and
the second frame is output for transmission via the bandwidth portion indicated in the trigger frame.

6. The apparatus of claim 1, wherein:
the first frame is obtained via a first bandwidth channel;
the plurality of bandwidth channels comprises a second bandwidth channel; and
the second frame is output for transmission via at least one of time or frequency resources of the second bandwidth channel.

7. The apparatus of claim 1, wherein the processing system is configured:
to track a network allocation vector (NAV) having duration values for the plurality of the bandwidth channels; and
to determine at least one of time or frequency resources for bandwidth channels are unavailable if a correspond duration value is non-zero.

8. A method for wireless communication by an apparatus, comprising:
obtaining at least a first frame with an indication of a time duration during which at least one bandwidth channel is occupied;
determining, based at least in part on the indicated time duration, whether at least one of time or frequency resources are available on a plurality of bandwidth channels including the at least one bandwidth channel, wherein none of the plurality of bandwidth channels overlap in frequency;
generating a second frame if it is determined that the at least one of time or frequency resources on the plurality of bandwidth channels are available; and
outputting the second frame for transmission via the at least one of time or frequency resources determined available on the plurality of bandwidth channels.

9. The method of claim 8, wherein:
the indication further comprises an indication of which of the plurality of bandwidth channels are unavailable during the time duration.

10. The method of claim 8, wherein:
the indication further comprises an indication of a separate duration, for each unavailable bandwidth channel of the plurality of bandwidth channels, during which the respective unavailable bandwidth channel is occupied.

11. The method of claim 8, wherein:
the first interface is further configured to obtain a trigger frame; and
the second frame is output for transmission after reception of the trigger frame.

12. The method of claim 11, wherein:
the trigger frame indicates the apparatus is to output the second frame for transmission on a scheduled bandwidth portion of one of the plurality of bandwidth channels; and
the second frame is output for transmission via the bandwidth portion indicated in the trigger frame.

13. The method of claim 8, wherein:
the first frame is obtained via a first bandwidth channel;
the plurality of bandwidth channels comprises a second bandwidth channel; and
the second frame is output for transmission via at least one of time or frequency resources of the second bandwidth channel.

14. The method of claim 8, wherein the determining comprises:
tracking a network allocation vector (NAV) having duration values for the plurality of the bandwidth channels; and
determining at least one of time or frequency resources for bandwidth channels are unavailable if a correspond duration value is non-zero.

15. An apparatus for wireless communication, comprising:
means for obtaining at least a first frame with an indication of a time duration during which at least one bandwidth channel is occupied;
means for determining, based at least in part on the indicated time duration, whether at least one of time or frequency resources are available on a plurality of bandwidth channels including the at least one bandwidth channel, wherein none of the plurality of bandwidth channels overlap in frequency;
means for generating a second frame if it is determined that the at least one of time or frequency resources on the plurality of bandwidth channels are available; and
means for outputting the second frame for transmission via the at least one of time or frequency resources determined available on the plurality of bandwidth channels.

16. The apparatus of claim 15, wherein:
the indication further comprises an indication of which of the plurality of bandwidth channels are unavailable during the time duration.

17. The apparatus of claim 15, wherein:
the indication further comprises an indication of a separate duration, for each unavailable bandwidth channel of the plurality of bandwidth channels, during which the respective unavailable bandwidth channel is occupied.

18. The apparatus of claim 15, wherein:
the first interface is further configured to obtain a trigger frame; and
the second frame is output for transmission after reception of the trigger frame.

19. The apparatus of claim 18, wherein:
the trigger frame indicates the apparatus is to output the second frame for transmission on a scheduled bandwidth portion of one of the plurality of bandwidth channels; and
the second frame is output for transmission via the bandwidth portion indicated in the trigger frame.

20. The apparatus of claim 15, wherein:
the first frame is obtained via a first bandwidth channel;
the plurality of bandwidth channels comprises a second bandwidth channel; and
the second frame is output for transmission via at least one of time or frequency resources of the second bandwidth channel.

21. The apparatus of claim 15, wherein the means for determining comprises:
means for tracking a network allocation vector (NAV) having duration values for the plurality of the bandwidth channels; and
means for determining at least one of time or frequency resources for bandwidth channels are unavailable if a correspond duration value is non-zero.

22. A computer readable medium having instructions stored thereon for:
obtaining at least a first frame with an indication of a time duration during which at least one bandwidth channel is occupied;
determining, based at least in part on the indicated time duration, whether at least one of time or frequency resources are available on a plurality of bandwidth channels including the at least one bandwidth channel, wherein none of the plurality of bandwidth channels overlap in frequency;
generating a second frame if it is determined that the at least one of time or frequency resources on the plurality of bandwidth channels are available; and
outputting the second frame for transmission via the at least one of time or frequency resources determined available on the plurality of bandwidth channels.

23. A wireless station, comprising:
at least one antenna;
a receiver configured to receive, via the at least one antenna, at least a first frame with an indication of a time duration during which at least one bandwidth channel is occupied;
a processing system configured to:
determine, based at least in part on the indicated time duration, whether at least one of time or frequency resources are available on a plurality of bandwidth channels including the at least one bandwidth channel, wherein none of the plurality of bandwidth channels overlap in frequency, and
generate a second frame if it is determined that the at least one of time or frequency resources on the plurality of bandwidth channels are available; and
a transmitter configured to transmit, via the at least one antenna, the second frame via the at least one of time or frequency resources determined available on the plurality of bandwidth channels.
